(19) United States
(12) Patent Application Publication
(10) Pub. No.: US 2006/0017709 A1
(43) Pub. Date: Jan. 26, 2006

(54) Touch panel apparatus, method of detecting touch area, and computer product

(75) Inventor: Akihiro Okano, Tokyo (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/185,754

(22) Filed: Jul. 21, 2005

(30) Foreign Application Priority Data
Jul. 22, 2004 (JP) 2004-214862

(51) Int. Cl. G09G 5/00

(52) U.S. Cl. 345/173

(57) ABSTRACT

A touch panel apparatus includes a touch panel provided on a display; a touch-area detecting unit that detects a touch area when an object touches on a surface of the touch panel; and a determining unit that compares, when the touch-area detecting unit detects two touch areas, dimensions of the two touch areas, validates a touch area having a smaller dimension, and invalidates a touch area having a larger dimension.

### BACKGROUND OF THE INVENTION

1. Field of the Invention

The present invention relates to a technology for preventing an error due to detection of two touch areas in a touch panel apparatus.

2. Description of the Related Art

Conventionally, a touch panel apparatus that detects a position touched with a touch pen or a finger on coordinates is proposed (see, for example, Japanese Patent Application Laid-open Nos. 2002-149348, 2001-312370, and 2001-306241). The touch panel apparatus has a touch panel provided on the surface of a liquid-crystal display (LCD), a plasma display panel (PDP), or a cathode ray tube (CRT). The touch panel detects a position on coordinates at which a touch pen or the like touches on the touch panel.

Specifically, plural light-emitting elements (not shown) are laid out on one vertical side 11a and one horizontal side 11b of a touch panel 11 of a touch panel apparatus 10 shown in FIG. 11. Plural light-receiving elements (not shown) are laid out at the other vertical side 11c and the other horizontal side 11d that are opposite to the light-emitting elements. The touch panel is provided on the surface of the LCD, the PDP, or the CRT (not shown).

In the above configuration, when a touch pen 20 touches an optional touch area a₁ on the touch panel 11, the touch area a₁ shields light emitted from the light-emitting elements on the vertical side 11a and light emitted from the light-emitting elements on the horizontal side 11b. Consequently, the light-receiving elements on the opposite vertical side 11c and on the opposite horizontal side 11d respectively cannot receive the lights that are emitted and shielded. Accordingly, the touch area a₁ (x-y coordinates) is detected from the layout positions of the light-receiving elements that do not receive the lights.

According to the conventional touch panel apparatus 10, when the touch pen 20 touches on the touch panel 11, a hand 30 also touches on the touch panel 11 by mistake. In this case, as shown in FIG. 11, a touch area a₂ on which the hand 30 touches is also detected in addition to the primary touch area a₁. The detection of the two touch areas causes an error.

### SUMMARY OF THE INVENTION

It is an object of the present invention to at least solve the problems in the conventional technology.

A touch panel apparatus according to one aspect of the present invention includes a touch panel provided on a display; a touch-area detecting unit that detects a touch area when an object touches on a surface of the touch panel; and a determining unit that compares, when the touch-area detecting unit detects two touch areas, dimensions of the two touch areas, validates a touch area having a smaller dimension, and invalidates a touch area having a larger dimension.

A touch panel apparatus according to another aspect of the present invention includes a touch panel provided on a display; a touch-area detecting unit that detects a touch area when an object touches on a surface of the touch panel; and a determining unit that compares, when the touch-area detecting unit detects two touch areas, temporal change rates of dimensions of the two touch areas, validates a touch area having a larger change rate, and invalidates a touch area having a smaller change rate.

A method of detecting a touch area on a touch panel, according to still another aspect of the present invention, includes detecting a touch area when an object touches on a surface of the touch panel; and determining including comparing, when two touch areas are detected at the detecting, dimensions of the two touch areas, validating a touch area having a smaller dimension, and invalidating a touch area having a larger dimension.

A method of detecting a touch area on a touch panel, according to still another aspect of the present invention, includes detecting a touch area when an object touches on a surface of the touch panel; and determining including comparing, when two touch areas are detected at the detecting, temporal change rates of dimensions of the two touch areas, validating a touch area having a larger change rate, and invalidating a touch area having a smaller change rate.

A computer-readable recording medium according to still another aspect of the present invention stores a computer program that causes a computer to execute the above methods according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a touch panel apparatus according to an embodiment of the present invention;

FIG. 2 depicts a user profile information registration screen according to the present embodiment;

FIG. 3 is an explanatory diagram of a registration operation of user profile information according to the present embodiment;

FIG. 4 is another explanatory diagram of a registration operation of user profile information according to the present embodiment;

FIG. 5 is a flowchart for explaining the operation of drawing characters with a touch pen;

FIG. 6 is an explanatory diagram of the drawing operation with the touch pen;

FIG. 7 is a cross-sectional diagram of the touch panel apparatus in the drawing operation cut along a line A-A;

FIG. 8 is a graph of a temporal change of dimensions of a touch area ar₁ shown in FIG. 7;

FIG. 9 is a graph of a temporal change of dimensions of a touch area ar₂ shown in FIG. 7;

FIG. 10 is a block diagram of a computer system for the touch panel apparatus according to the present embodiment; and

FIG. 11 is a schematic of a conventional touch panel apparatus.

### DETAILED DESCRIPTION OF THE PREFERRED EMBODIMENTS

Exemplary embodiments of the present invention will be explained below in detail with reference to the accompanying drawings. It should be noted that the invention will not be limited by the present embodiments.

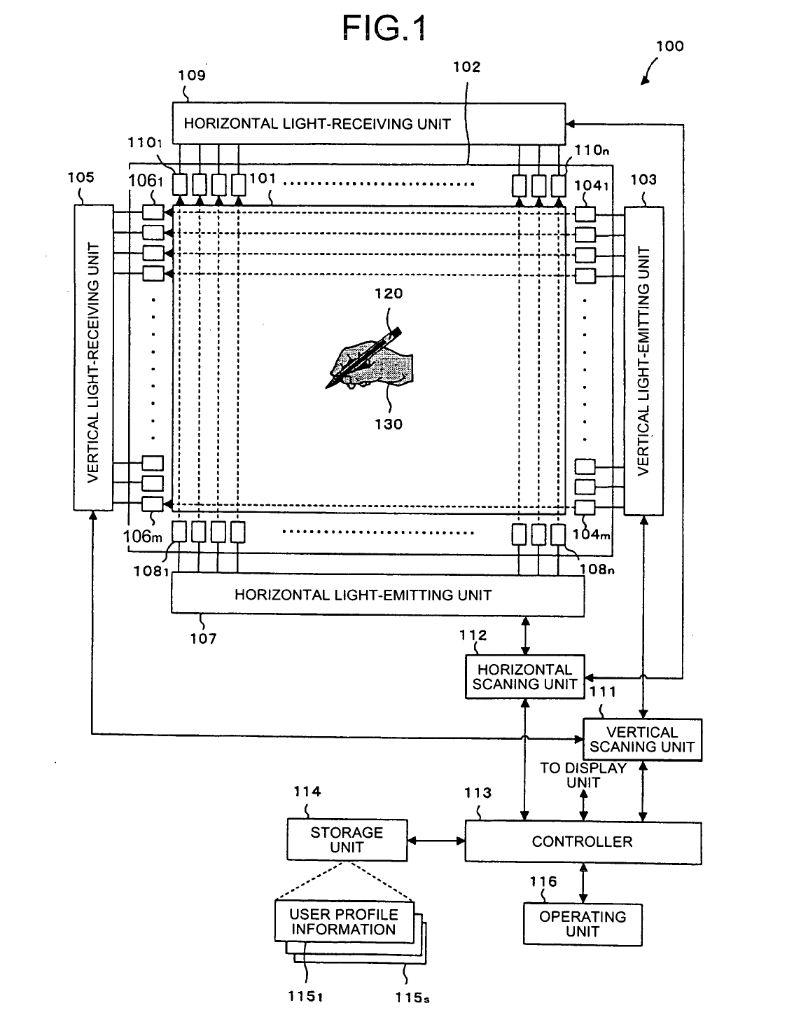

FIG. 1 is a block diagram of a touch panel apparatus 100 according to one embodiment of the present invention. In FIG. 1, a display unit 101 is an LCD, a PDP, or a CRT, which displays various kinds of information. A touch panel 102 is provided on the surface of the display unit 101. The touch panel 102 detects a touch area (expressed by x-y coordinates, for example) on which a touch pen 120 held in a hand 130 touches.

A vertical light-emitting unit 103 and a vertical light-receiving unit 105 are disposed opposite to each other on both vertical sides of the display unit 101, and have functions of emitting light (including an infrared ray) and receiving light respectively. In other words, the vertical light-emitting unit 103 and the vertical light-receiving unit 105 detect a shielding of light when the light is shielded with the touch pen 120 or the hand 130. The vertical light-emitting unit 103 drives m light-emitting elements 104₁ to 104ₘ that are laid out at predetermined intervals in a vertical direction, thereby making the light-emitting elements 104₁ to 104ₘ generate light respectively.

The vertical light-receiving unit 105 drives m light-receiving elements 106₁ to 106ₘ that are laid out at predetermined intervals in a vertical direction corresponding to the light-emitting elements 104₁ to 104ₘ respectively, thereby making the light-receiving elements 106₁ to 106ₘ receive light emitted from the light-emitting elements 104₁ to 104ₘ respectively.

A horizontal light-emitting unit 107 and a horizontal light-receiving unit 109 are disposed opposite to each other on both horizontal sides of the display unit 101, and have functions of emitting light (including an infrared ray) and receiving light respectively. The horizontal light-emitting unit 107 drives n light-emitting elements 108₁ to 108ₙ that are laid out at predetermined intervals in a horizontal direction, thereby making the light-emitting elements 108₁ to 108ₙ generate light respectively.

The horizontal light-receiving unit 109 drives n light-receiving elements 110₁ to 110ₙ that are laid out at predetermined intervals in a horizontal direction corresponding to the light-emitting elements 108₁ to 108ₙ respectively, thereby making the light-receiving elements 110₁ to 110₁ receive light emitted from the light-emitting elements 108₁ to 108ₙ respectively.

A vertical scan unit 111 scans the vertical light-emitting unit 103 and the vertical light-receiving unit 105 in a vertical direction based on the control of a controller 113. A horizontal scan unit 112 scans the horizontal light-emitting unit 107 and the horizontal light-receiving unit 109 in a horizontal direction based on the control of the controller 113. The controller 113 controls each unit. Details of the operation of the controller 113 are described later. A storage unit 114 stores user profile information 115₁ to 115ₛ.

These user profile information 115₁ to 115ₛ correspond to s users, and have user's specific information based on each user's habit of touching (by mistake) the touch panel with a hand when using the touch pen 120 and a structure of the hand. Details of the user profile information 115₁ to 115ₛ are described later.

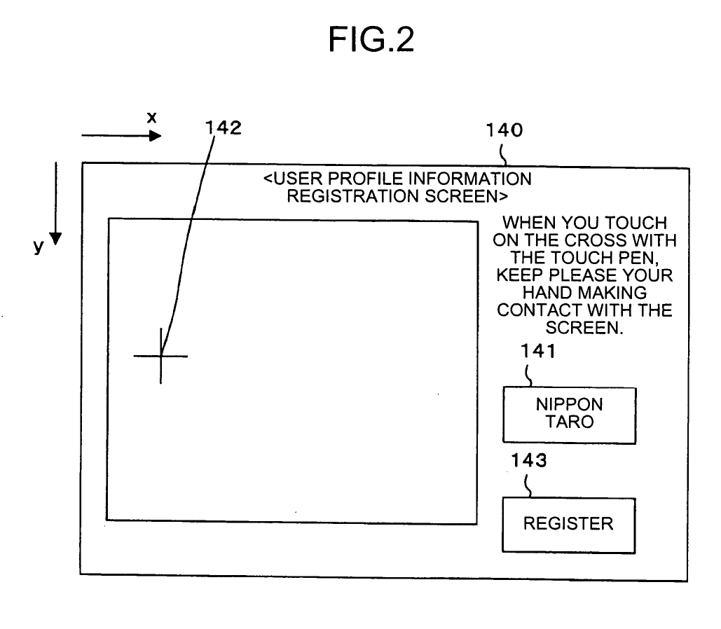

The operation of the touch panel apparatus according to one embodiment is explained below with reference to FIGS. 2 to 9. First, the operation of registering user profile information into the storage unit 114 is explained with reference to FIGS. 2 to 4. When a user operates an operating unit 116 to instruct a registration, the controller 113 makes a user profile information registration screen 140 shown in FIG. 2 to be displayed in the display unit 101 (see FIG. 1).

The user profile information registration screen 140 is used to register user profile information by making a user intentionally touch the touch panel with a hand. The user profile information registration screen 140 displays a user name input column 141, a cross mark 142, and a registration button 143.

A user name is input to the user name input column 141. The cross mark 142 displays a reference position at which a front end of the touch pen 12 (see FIG. 1) is to be touched. The registration button 143 is used to register the user profile information.

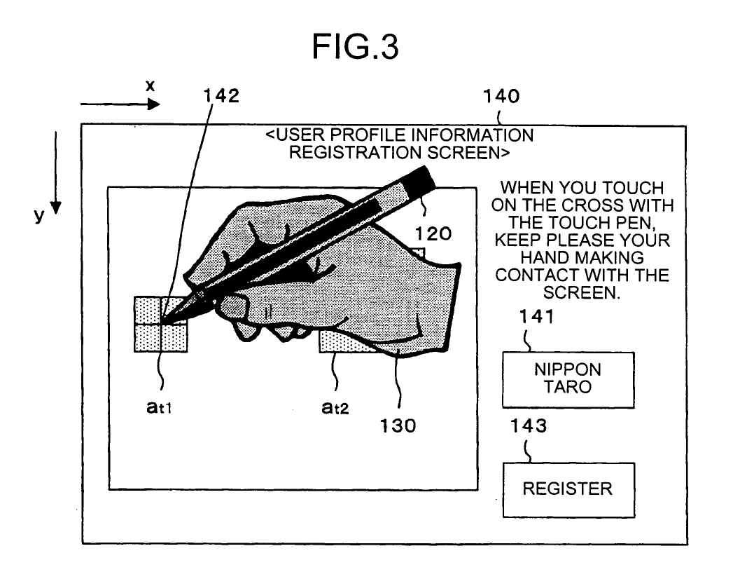

A right-handed user operates the operating unit 116 to input “Nippon Taro” as a user name into the user name input column 141. As shown in FIG. 3, in a state that the user holds the touch pen 120 in the right hand 130, the front end of the touch pen 120 touches on the cross mark 142, and the user intentionally touches on the user profile information registration screen 140 (the touch panel 102) with the hand 130.

The front end of the touch pen 120 and a part of the hand 130 shield the light. The horizontal scan unit 112 and the vertical scan unit 111 detect a touch area aₜ₁ and a touch area aₜ₂. A result of the detection is output to the controller 113. The touch area aₜ₁ corresponds to the area in which light is shielded by the front end of the touch pen 120.

On the other hand, the touch area aₜ₂ is positioned at the right of the touch area aₜ₁, and corresponds to the area in which light is shielded by a part of the hand 130. Light-shielded dimensions of the touch area aₜ₁ and the touch area aₜ₂ shown in FIG. 3 are larger than the actual light-shielding dimensions to facilitate the understanding of these areas. The user takes off the hand 130 holding the touch pen 120 from the user profile information registration screen 140.

The controller 113 recognizes the x coordinates at the left end of the touch area aₜ₁ and the touch area aₜ₂ respectively, and generates the user profile information 115₁ covering the user name (“Nippon Taro”) that is input to the user name input column 141, dimensions of the touch area aₜ₁, the x coordinate at the left end of the touch area aₜ₁, dimensions of the touch area aₜ₂, and the x coordinate at the left end of the touch area aₜ₂.

When the user presses the registration button 143, the controller 113 registers the user profile information 115₁ into the storage unit 114. Thereafter, user profile information of other users are also registered.

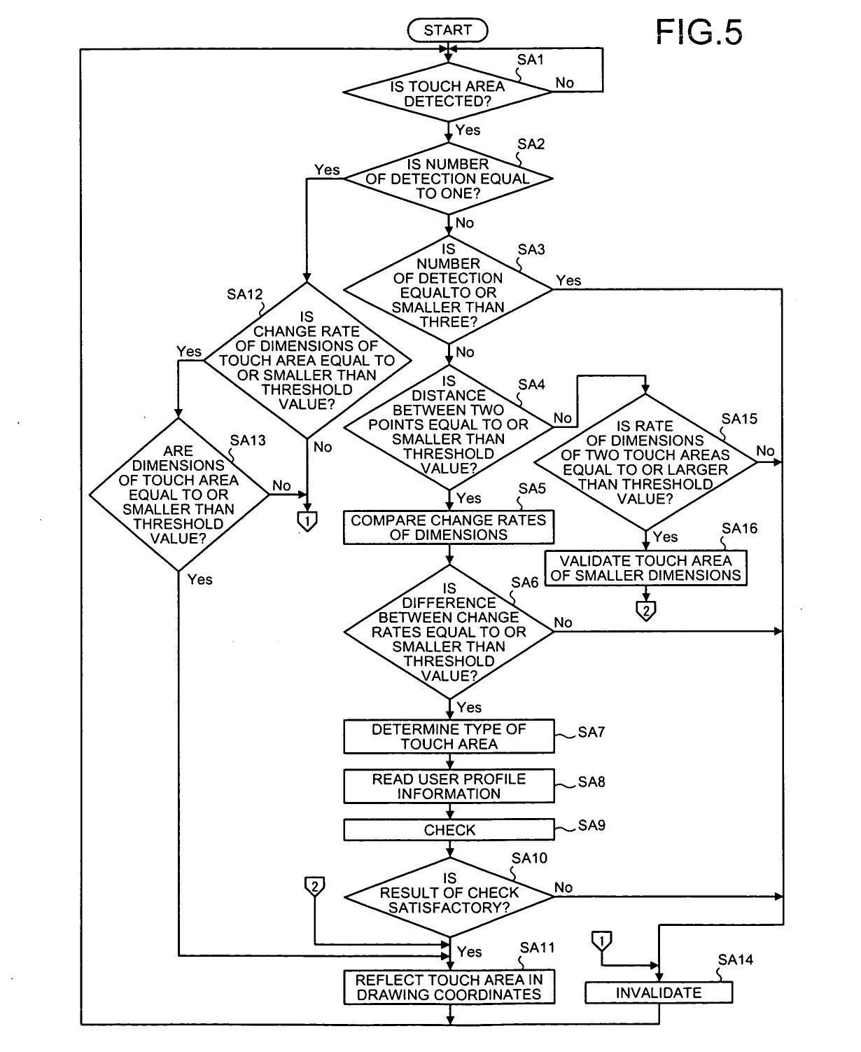

A drawing operation with the touch pen 120 will be explained next with reference to FIGS. 5 to 9. FIG. 5 is a flowchart for explaining the operation of drawing characters or the like with the touch pen 120. An example that Nippon Taro, as a user, draws characters with the touch pen 120 will be explained next. In using the touch panel apparatus 100, Nippon Taro inputs his own name from the operating unit 116, and this is recognized by the controller 113.

At step SA1 in FIG. 5, the controller 113 determines whether a touch area is detected in the touch panel 102 (the display unit 101), based on a result of detections carried out by the vertical scan unit 111 and the horizontal scan unit 112. In this case, the controller 113 sets “No” as a result of the determination, and the controller 113 repeats this determination.

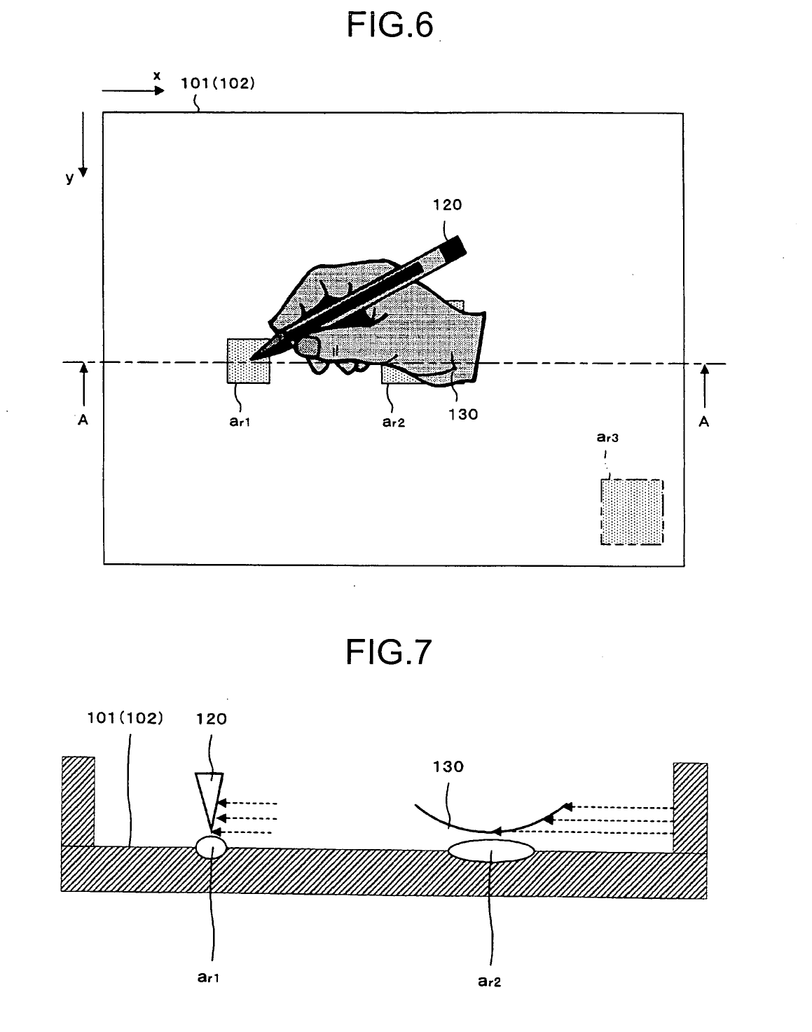

Nippon Taro holds the touch pen 120 in the hand 130, and touches the display unit 101 (the touch panel 102) with the front end of the touch pen 120, as shown in FIG. 6. A touch area aᵣ₁ corresponds to the front end of the touch pen 120, and the area is detected as a light-shielded area. In this case, it is assumed that the hand 130 does not touch on the display unit 101 (the touch panel 102).

The controller 113 sets “Yes” as a result of the determination at step SA1. At step SA2, the controller 113 determines whether one touch area is detected within a predetermined time. In this case, the controller 113 sets “Yes” as a result of the determination.

At step SA12, the controller 113 determines whether a change rate of the dimensions of the touch area aᵣ₁ after a lapse of a predetermined time since the detection at step SA1 is equal to or smaller than a threshold value set in advance. In other words, the controller 113 determines whether the dimensions of the touch area aᵣ₁ are stable. In this case, the controller 113 sets “Yes” as a result of the determination. When a result of the determination made at step SA12 is “No”, the controller 113 invalidates the touch area aᵣ₁ at step SA14, and the controller 113 makes a determination at step SA1.

At step SA13, the controller 113 determines whether the dimensions of the touch area aᵣ₁ are equal to or smaller than a threshold value set in advance. In other words, the controller 113 determines whether the dimensions of the touch area aᵣ₁ correspond to the dimensions of the front end of the touch pen 120. In this case, the controller 113 sets “Yes” as a result of the determination. When a result of the determination made at step SA13 is “No”, the controller 113 regards that the touch area aᵣ₁ corresponds to a touch (by mistake) of the hand 130, and invalidates the touch area aᵣ₁ at step SA14.

At step SA11, the controller 113 reflects the touch area aᵣ₁ in the drawing coordinates of the x-y coordinate system, and makes the display unit 101 draw the touch area aᵣ₁. The controller 113 then makes a determination at step SA1.

The operation when the hand is touched (by mistake) on the touch panel will be explained next. In this case, as shown in FIG. 6, when Nippon Taro touches the display unit 101 (the touch panel 102) with the front end of the touch pen 120 in the state of holding the touch pen 120 in the hand 130, Nippon Taro also unconsciously touches the display unit 101 (the touch panel 102) with the hand 130.

As described above, the touch area aᵣ₁ corresponds to the front end of the touch pen 120, and the area is detected as a light-shielded area. On the other hand, the touch area aᵣ₂ corresponds to a part of the hand 130, and the area is detected as a light-shielded area. In this case, two touch areas of the touch area aᵣ₁ and the touch area aᵣ₂ are detected.

Accordingly, the controller 113 sets “Yes” as a result of the determination at step SA1. At step SA2, the controller 113 determines whether one touch area is detected within a predetermined time. In this case, the controller 113 sets “No” as a result of the determination.

At step SA3, the controller 113 determines whether three or more touch areas are detected. In this case, the controller 113 sets “No” as a result of the determination. At step SA4, the controller 113 determines whether a distance between a left end point (for example, a left lower point) of the touch area aᵣ₁ and a left end point (for example, a left lower point) of the touch area aᵣ₂ is equal to or smaller than a threshold value set in advance. In this case, the controller 113 sets “Yes” as a result of the determination.

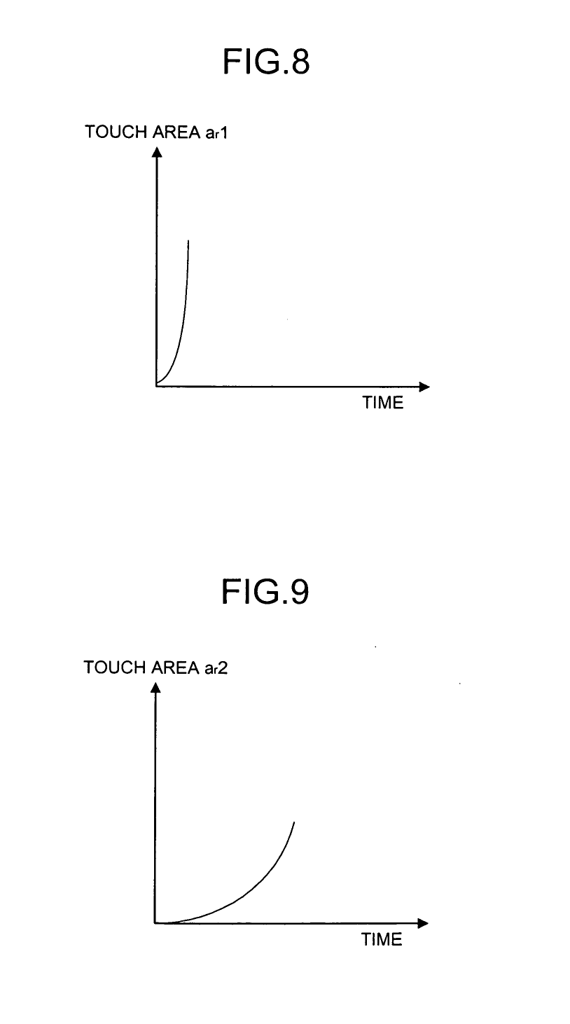

At step SA5, the controller 113 compares a change rate of the dimensions of the touch area aᵣ₁ with a change rate of the dimensions of the touch area aᵣ₂. Specifically, a change rate of the dimensions of the touch area aᵣ₁ corresponding to the touch pen 120 shown in FIG. 7 is expressed in a graph of time-dimension characteristics shown in FIG. 8, and this change rate is very large. On the other hand, a change rate of the dimensions of the touch area aᵣ₂ corresponding to the hand 130 shown in FIG. 7 is expressed in a graph of time-dimension characteristics shown in FIG. 9, and this change rate is smaller than that of the graph shown in FIG. 8.

When the change rate of the dimensions of the touch area is equal to or larger than a threshold value, the controller 113 determines that the touch area corresponds to the touch pen. On the other hand, when the change rate of the dimensions of the touch area is smaller than a threshold value, the controller 113 determines that the touch area corresponds to the hand. These determination standards are used at step SA7 described later.

At step SA6, the controller 113 determines whether a difference between the change rate of the dimensions of the touch area aᵣ₁ and the change rate of the dimensions of the touch area aᵣ₂ is equal to or larger than a threshold value set in advance. In this case, the controller 113 sets “Yes” as a result of the determination. When a result of the determination made at step SA6 is “No”, the controller 113 invalidates the touch area aᵣ₁ and the touch area aᵣ₂ at step SA14.

At step SA7, the controller 113 determines types of the touch area aᵣ₁ and the touch area aᵣ₂ based on the above determination standards. In this case, it is regarded that a change rate of the dimensions of the touch area aᵣ₁ is equal to or larger than a threshold value, and the controller 113 determines that the type of the touch area aᵣ₁ is the touch pen area, accordingly. It is also regarded that a change rate of the dimensions of the touch area aᵣ₂ is smaller than a threshold value, and the controller 113 determines that the type of the touch area aᵣ₂ is the hand area, accordingly.

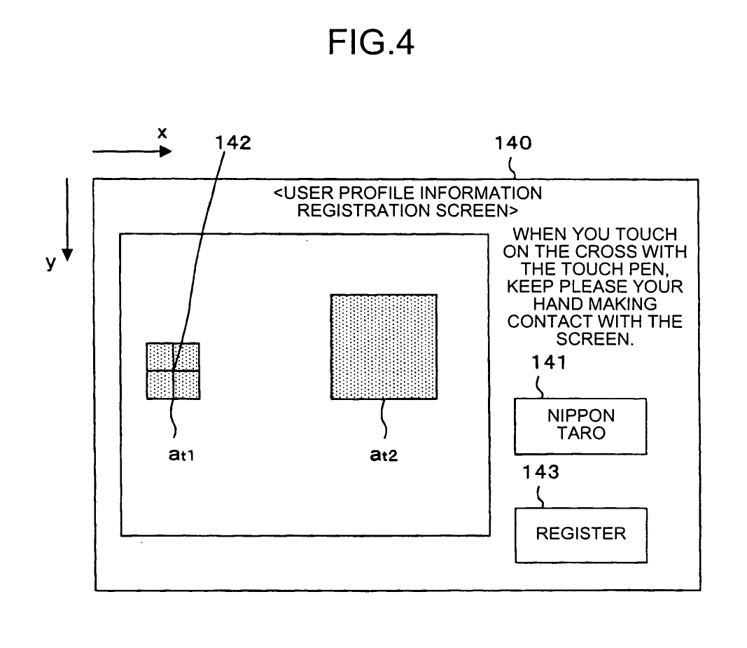

At step SA8, the controller 113 reads the user profile information 115₁ corresponding to Nippon Taro from the storage unit 114. At step SA9, the controller 113 checks the touch area aᵣ₁ and the touch area aᵣ₂ that are actually detected with the touch area aₜ₁ and the touch area aₜ₂ (see FIG. 4) that correspond to the user profile information 115₁.

At step SA10, the controller 113 determines whether a result of the check at step SA9 is satisfactory. A result of the check is satisfactory, for example, when a correlation between the touch area aᵣ₁ and the touch area aᵣ₂ and the touch area aₜ₁ and the touch area aₜ₂ (see FIG. 4) is equal to or higher than a threshold value. When a result of the determination made at step SA10 is “Yes”, the controller 113 validates the touch area aᵣ₁ having a small area and having a large change rate, and reflects the touch area aᵣ₁ in the drawing coordinates at step SA11. When a result of the determination made at step SA10 is “No”, the controller 113 invalidates the touch area aᵣ₁ and the touch area aᵣ₂ at step SA14.

At step SA11, the controller 113 validates the touch area aᵣ₁ (the touch pen area) and invalidates the touch area aᵣ₂ (the hand area), reflects the touch area aᵣ₁ in the drawing coordinates of the x-y coordinate system, makes the display unit 101 draw the touch area aᵣ₁, and determines at step SA1. In other words, the controller validates the touch area aᵣ₁ and invalidates the touch area aᵣ₂ when the area of the touch area (hereinafter, “first parameter”), a change rate (hereinafter, “second parameter”), and a correlation with the user profile information (the touch area aₜ₁ and the touch area aₜ₂) (hereinafter, “third parameter”) are equal to or larger than threshold values respectively.

While the controller 113 determines whether the touch areas are valid based on all of the first to the third parameters in the above embodiment, the controller 113 can also determine whether the touch areas are valid based on any one of the first to the third parameters.

When the other hand also touches on the display unit 101 (the touch panel 102), and a touch area aᵣ₃ (corresponding to the other hand) is also detected in addition to the touch area aᵣ₁ and the touch area aᵣ₂, and three touch areas are detected as shown in FIG. 6, the controller 113 sets “Yes” as a result of the determination at step SA3. At step SA14, the controller 113 invalidates the touch areas aᵣ₁ to aᵣ₃.

When a result of the determination made at step SA4 is “No”, the controller 113 determines at step SA15 whether a ratio of the dimensions of the two touch areas is equal to or larger than a threshold value set in advance. When a result of the determination made at step SA15 is “No”, the controller 113 invalidates the two touch areas at step SA14.

On the other hand, when a result of the determination made at step SA15 is “Yes”, the controller 113 validates the touch area of smaller dimensions and invalidates the touch area of larger dimensions out of the two touch areas at step SA16. At step SA11, the controller 113 reflects the validated touch area of the smaller dimensions in the drawing coordinates of the x-y coordinate system, and makes the display area 101 draw the touch area.

As explained above, according to the above embodiment, when objects (the touch pen 120 and the hand 130) touch on the surface of the touch panel 102 (the display unit 101) and when the controller 113 detects two touch areas of the touch area aᵣ₁ and the touch area aᵣ₂, the controller compares the dimensions of the two touch areas (the touch area aᵣ₁ and the touch area aᵣ₂). The controller validates the touch area of smaller dimensions and invalidates the touch area of larger dimensions. Therefore, it is possible to prevent errors due to detection of two touch areas.

Furthermore, according to the above embodiment, the controller 113 compares the dimensions of the two touch areas, and compares temporal change rates of dimensions of the two touch areas. The controller 113 validates a touch area having smaller dimensions and having a large change rate, and invalidates a touch area having larger dimensions and having a small change rate. Therefore, it is possible to prevent errors due to detection of two touch areas.

Furthermore, according to the above embodiment, when the two touch areas are detected, the controller 113 determines whether each touch area is valid based on the correlation between the two touch areas obtained from the profile information 115₁ (for example, the touch area aₜ₁ and the touch area aₜ₂ shown in FIG. 3) and the two touch areas that are detected. Therefore, it is possible to prevent errors due to detection of two touch areas because of a habit of the user or the like.

While an embodiment of the present invention has been explained above with reference to the accompanying drawings, specific configurations of the invention are not limited thereto. In addition, any design modifications without departing from the scope of the invention are included in the present invention.

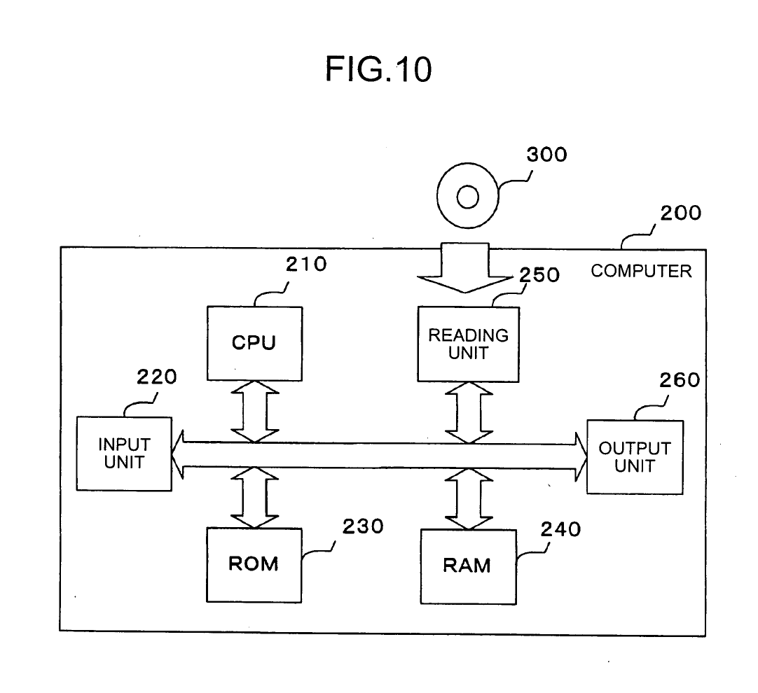

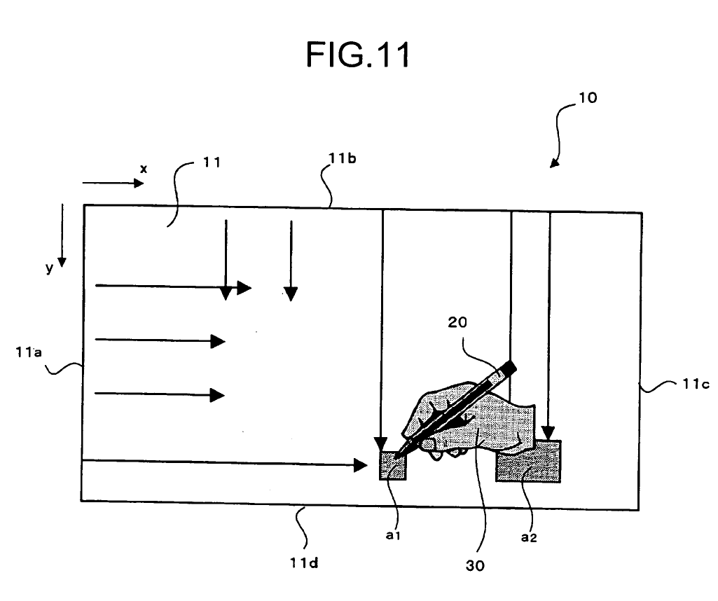

For example, according to the present embodiment, a program that achieves the functions of the touch panel apparatus 100 can be recorded onto a computer-readable recording medium 300 shown in FIG. 10. A computer 200 shown in FIG. 10 can read the program recorded on the recording medium 300, and execute the program to achieve the functions.

The computer 200 shown in FIG. 10 includes a central processing unit (CPU) 210 that executes the program, an input device 220 such as a keyboard and a mouse, a read-only memory (ROM) 230 that stores various kinds of data, a random access memory (RAM) 240 that stores operation parameters, a reading unit 250 that reads the program from the recording medium 300, and an output unit 260 such as a display and a printer.

The CPU 210 reads the program recorded on the recording medium 300 via the reading unit 250, and executes the program to achieve the above functions. The recording medium 300 includes an optical disk, a flexible disk, and a hard disk.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A touch panel apparatus comprising:
a touch panel provided on a display;
a touch-area detecting unit that detects a touch area when an object touches on a surface of the touch panel; and
a determining unit that compares, when the touch-area detecting unit detects two touch areas, dimensions of the two touch areas, validates a touch area having a smaller dimension, and invalidates a touch area having a larger dimension.

2. The touch panel apparatus according to claim 1, wherein
the determining unit further compares temporal change rates of the dimensions of the two touch areas, validates a touch area having a smaller dimension and a larger change rate, and invalidates a touch area having a larger dimension and a smaller change rate.

3. The touch panel apparatus according to claim 1, further comprising a registering unit that registers information on two touch areas obtained by having a user use the touch panel in advance, as user profile information, wherein
when the touch-area detecting unit detects two touch areas, the determining unit determines a validation of the touch areas based on a correlation between the two touch areas obtained from the user profile information and the two touch areas detected.

4. A touch panel apparatus comprising:
a touch panel provided on a display;
a touch-area detecting unit that detects a touch area when an object touches on a surface of the touch panel; and
a determining unit that compares, when the touch-area detecting unit detects two touch areas, temporal change rates of dimensions of the two touch areas, validates a touch area having a larger change rate, and invalidates a touch area having a smaller change rate.

5. The touch panel apparatus according to claim 4, further comprising a registering unit that registers information on two touch areas obtained by having a user use the touch panel in advance, as user profile information, wherein
when the touch-area detecting unit detects two touch areas, the determining unit determines a validation of the touch areas based on a correlation between the two touch areas obtained from the user profile information and the two touch areas detected.

6. A method of detecting a touch area on a touch panel, the method comprising:
detecting a touch area when an object touches on a surface of the touch panel; and
determining including
comparing, when two touch areas are detected at the detecting, dimensions of the two touch areas;
validating a touch area having a smaller dimension; and
invalidating a touch area having a larger dimension.

7. The method according to claim 6, wherein
the comparing includes comparing temporal change rates of the dimensions of the two touch areas;
the validating includes validating a touch area having a smaller dimension and a larger change rate; and
the invalidating includes invalidating a touch area having a larger dimension and a smaller change rate.

8. The method according to claim 6, further comprising registering information on two touch areas obtained by having a user use the touch panel in advance, as user profile information, wherein
when two touch areas are detected at the detecting, the determining includes determining a validation of the touch areas based on a correlation between the two touch areas obtained from the user profile information and the two touch areas detected.

9. A method of detecting a touch area on a touch panel, the method comprising:
detecting a touch area when an object touches on a surface of the touch panel; and
determining including
comparing, when two touch areas are detected at the detecting, temporal change rates of dimensions of the two touch areas;
validating a touch area having a larger change rate; and
invalidating a touch area having a smaller change rate.

10. The method according to claim 9, wherein
the comparing includes comparing temporal change rates of the dimensions of the two touch areas;
the validating includes validating a touch area having a smaller dimension and a larger change rate; and
the invalidating includes invalidating a touch area having a larger dimension and a smaller change rate.

11. A computer-readable recording medium that stores a computer program for detecting a touch area on a touch panel, wherein the computer program causes a computer to execute:
detecting a touch area when an object touches on a surface of the touch panel; and
determining including
comparing, when two touch areas are detected at the detecting, dimensions of the two touch areas;
validating a touch area having a smaller dimension; and
invalidating a touch area having a larger dimension.

12. The computer-readable recording medium according to claim 11, wherein
the comparing includes comparing temporal change rates of the dimensions of the two touch areas;
the validating includes validating a touch area having a smaller dimension and a larger change rate; and
the invalidating includes invalidating a touch area having a larger dimension and a smaller change rate.

13. The computer-readable recording medium according to claim 11, wherein
the computer program further causes the computer to execute registering information on two touch areas obtained by having a user use the touch panel in advance, as user profile information, and
when two touch areas are detected at the detecting, the determining includes determining a validation of the touch areas based on a correlation between the two touch areas obtained from the user profile information and the two touch areas detected.

14. A computer-readable recording medium that stores a computer program for detecting a touch area on a touch panel, wherein the computer program causes a computer to execute:
detecting a touch area when an object touches on a surface of the touch panel; and
determining including
comparing, when two touch areas are detected at the detecting, temporal change rates of dimensions of the two touch areas;
validating a touch area having a larger change rate; and
invalidating a touch area having a smaller change rate.

15. The computer-readable recording medium according to claim 14, wherein
the comparing includes comparing temporal change rates of the dimensions of the two touch areas;
the validating includes validating a touch area having a smaller dimension and a larger change rate; and
the invalidating includes invalidating a touch area having a larger dimension and a smaller change rate.

16. A touch panel apparatus comprising:
a touch detecting unit that detects touch of an object on a surface of a touch panel; and
an area determining unit that determines touch areas of each touch when the touch detecting unit detects a plurality of touches any one of simultaneously and during a predetermined time period; and
a validating unit that validates a touch as a touch of an object based on touch area.

17. The touch panel apparatus according to claim 16, further comprising:
a temporal-change-rate determining unit that determines temporal change rates of the touch areas detected by the area determining unit, wherein
the validating unit validates a touch as a touch of the object based on a temporal change rate.

18. The touch panel apparatus as set forth in claim 16, wherein the validating unit validates a touch as a touch of the object based on the smallest touch area.

19. A touch panel apparatus comprising:
a touch detecting unit that detects touch of an object on a surface of a touch panel; and
an area determining unit that determines touch areas of each touch when the touch detecting unit detects a plurality of touches any one of simultaneously and during a predetermined time period;
a temporal-change-rate determining unit that determines temporal change rates of the touch areas determined by the area determining unit; and
a validating unit that validates a touch that corresponds to a largest temporal change rate as a touch of an object.
